(19) United States
(12) Patent Application Publication
(10) Pub. No.: US 2019/0030722 A1
(43) Pub. Date: Jan. 31, 2019

(54) CONTROL DEVICE, ROBOT SYSTEM, AND CONTROL METHOD

(71) Applicant: Seiko Epson Corporation, Tokyo (JP)

(72) Inventors: Yukihiro YAMAGUCHI, Matsumoto (JP); Nobuyuki SETSUDA, Okaya (JP); Taro ISHIGE, Matsumoto (JP)

(21) Appl. No.: 16/047,083

(22) Filed: Jul. 27, 2018

(30) Foreign Application Priority Data
Jul. 28, 2017 (JP) 2017-146229

(51) Int. Cl. B25J 9/16

(52) U.S. Cl. CPC B25J 9/1697; B25J 9/1692; B25J 9/1664

(57) ABSTRACT

A control device comprising a processor wherein the processor is configured to receive information relating to a first captured image from a first camera capable of capturing an image, perform a command relating to drive of the robot having a hand holding a workpiece based on the information, perform correlation between a robot coordinate system which is a coordinate system relating to a robot and a first image coordinate system which is a coordinate system relating to the first captured image, and perform the correlation, based on a coordinate in the robot coordinate system of a predetermined site of the hand holding the workpiece when the workpiece is located at each of a plurality of positions inside an imaging region of the first camera and a coordinate in the first image coordinate system of the workpiece when the workpiece is located at each of the plurality of positions.

### BACKGROUND

### 1. Technical Field

The present invention relates to a control device, a robot system, and a control method.

### 2. Related Art

In the related art, a robot system is known which has a robot for carrying out work on a workpiece and a camera (imaging unit) capable of imaging the workpiece. In this robot system, based on an image captured by the camera, the robot can carry out various types of work in a real space. In order for the robot to carry out the work based on the image, it is necessary to perform calibration (correlation) between an image coordinate system of the image captured by the camera and a robot coordinate system serving as a control reference of the robot. For example, it is necessary to perform the calibration between the image coordinate system using a two-dimensional image captured by the camera and the robot coordinate system in a two-dimensional space on a surface of a work table where the robot carries out the work.

JP-A-2016-187845 discloses a calibration method using a marker board provided with a plurality of markers. According to the method, position information is acquired using a robot coordinate of one marker, and position information is acquired using an image coordinate of the camera so that these two pieces of position information are combined with each other. In this manner, the calibration is performed between the robot coordinate system and the image coordinate system.

However, according to the method in the related art, a dedicated member such as the marker board needs to be prepared, thereby causing a worker to spend time and labor.

When the calibration is performed between the image coordinate system using the two-dimensional image and the robot coordinate system in the two-dimensional space on the surface of the work table, the calibration is not performed in a height direction on the work table. Therefore, if a height of the marker board and a height of the workpiece do not coincide with each other, the robot is less likely to carry out proper work by using a result of the calibration. Accordingly, the worker needs to prepare the marker board corresponding to the height of the workpiece, thereby causing a problem in that the worker feels unsatisfactory workability.

### SUMMARY

An advantage of some aspects of the invention is to solve at least a part of the problems described above, and the invention can be implemented as the following configurations.

A control device according to an application example of the invention includes a receiving unit that receives information relating to a first captured image from a first imaging unit capable of capturing an image, and a control unit capable of performing a command relating to drive of a robot having a movable unit capable of holding a workpiece, based on the information. The control unit is capable of performing correlation between a robot coordinate system which is a coordinate system relating to the robot and a first image coordinate system which is a coordinate system relating to the first captured image, and performs the correlation, based on a coordinate in the robot coordinate system of a predetermined site of the movable unit holding the workpiece when the workpiece is located at each of a plurality of positions inside an imaging region of the first imaging unit and a coordinate in the first image coordinate system of the workpiece when the workpiece is located at each of the plurality of positions.

According to this control device, calibration (correlation) can be performed using the workpiece. Accordingly, time and labor can be saved in preparing a dedicated member for the calibration, and workability of a worker can be improved. In addition, the calibration can be more accurately performed. A result of the calibration is used, thereby enabling a robot to more correctly carry out actual work on the workpiece.

In the control device according to the application example, it is preferable that, in the correlation, the control unit uses the first captured image captured when the workpiece is located at a first position inside the imaging region, and the first captured image captured when the workpiece is located at a second position different from the first position inside the imaging region.

In this manner, the calibration can be quickly, easily, and more accurately performed using one first imaging unit.

In the control device according to the application example, it is preferable that the workpiece includes a first workpiece and a second workpiece different from the first workpiece and, in the correlation, the control unit uses the first captured image captured when the first workpiece is located at a first position inside the imaging region, and the first captured image captured when the second workpiece is located at a second position different from the first position inside the imaging region.

In this way, the calibration can be performed using a plurality of the workpieces. Accordingly, time and labor can be saved in using a dedicated member for the calibration.

In the control device according to the application example, it is preferable that the workpiece includes a first workpiece and a second workpiece different from the first workpiece, and, in the correlation, the control unit uses the first captured image captured when the first workpiece is located at a first position inside the imaging region, and when the second workpiece is located at a second position different from the first position inside the imaging region.

In this manner, the calibration can be more quickly performed compared to a case of using the first captured image captured at each position.

In the control device according to the application example, it is preferable that, in the correlation, the control unit obtains a coordinate in the robot coordinate system of the predetermined site in a state where the workpiece is held by the movable unit, and obtains a coordinate in the first captured image of the workpiece after the workpiece is detached from the movable unit.

In this manner, the calibration can be correctly, quickly, and more accurately performed. In addition, the calibration can be more precisely performed.

In the control device according to the application example, it is preferable that the receiving unit is capable of communicating with the first imaging unit disposed so as to be capable of imaging a work table on which the workpiece is placed.

In this manner, the workpiece placed on the work table can be imaged, and the calibration can be correctly performed using the first captured image obtained by imaging the workpiece. Furthermore, when the robot carries out the work on the workpiece, the robot can properly carry out the work by using the first captured image.

In the control device according to the application example, it is preferable that the receiving unit is capable of receiving information relating to second captured image from a second imaging unit capable of capturing an image and different from the first imaging unit. It is preferable that the control unit is capable of coordinate transformation between the robot coordinate system and a second image coordinate system which is a coordinate system relating to the second captured image, and obtains a position of the workpiece with respect to the predetermined site, based on the coordinate transformation.

Even in a state where a position of the workpiece with respect to the predetermined site is unknown, it is possible to properly and easily perform the correlation between the first image coordinate system and the robot coordinate system.

In the control device according to the application example, it is preferable that the receiving unit is capable of communicating with the second imaging unit disposed so as to be capable of imaging the workpiece in a state where the workpiece is held by the movable unit.

In this manner, the position of the workpiece with respect to the predetermined site can be efficiently obtained.

A robot system according to an application example of the invention includes the control device according to the application example and a robot controlled by the control device.

According to this robot system, workability of the worker can be improved. The robot can more correctly, quickly, and accurately carry out the work on the workpiece.

A control method according to an application example of the invention includes correlating a robot coordinate system which is a coordinate system relating to a robot having a movable unit capable of holding a workpiece, and a first image coordinate system which is a coordinate system relating to a first captured image obtained from a first imaging unit capable of capturing an image, and driving the robot, based on a result of the correlating and information relating to the first captured image obtained from the first imaging unit. In the correlating, the correlating is performed, based on a coordinate in the robot coordinate system of a predetermined site of the movable unit holding the workpiece when the workpiece is located at each of a plurality of positions inside an imaging region of the first imaging unit and a coordinate in the first image coordinate system of the workpiece when the workpiece is located at each of the plurality of positions.

According to this control method, workability of the worker can be improved. The robot can more correctly, quickly, and accurately carry out the work on the workpiece.

### BRIEF DESCRIPTION OF THE DRAWINGS

The invention will be described with reference to the accompanying drawings, wherein like numbers reference like elements.

FIG. 1 illustrates a robot system according to a first embodiment.

FIG. 2 is a schematic view of the robot system illustrated in FIG. 1.

FIG. 3 is a block diagram of the robot system illustrated in FIG. 1.

FIG. 4 is a flowchart illustrating a control method of a robot controlled by a control device.

FIG. 5 illustrates an example of a workpiece.

FIG. 6 is a flowchart illustrating a calibration flow.

FIG. 7 is a view for describing Step S11 in FIG. 6.

FIG. 8 is a view for describing Step S11 in FIG. 6.

FIG. 9 is a view for describing Step S12 in FIG. 6.

FIG. 10 illustrates a first captured image.

FIG. 11 is a view for describing Step S14 in FIG. 6.

FIG. 12 illustrates the first captured image.

FIG. 13 illustrates the first captured image.

FIG. 14 illustrates the first captured image.

FIG. 15 is a flowchart illustrating an example of calibration using a plurality of workpieces.

FIG. 16 illustrates the first captured image.

FIG. 17 is a flowchart illustrating a calibration flow according to a second embodiment.

FIG. 18 illustrates the first captured image in Step S21 illustrated in FIG. 17.

FIG. 19 illustrates the first captured image in Step S22 illustrated in FIG. 17.

FIG. 20 illustrates a robot system according to a third embodiment.

FIG. 21 is a flowchart illustrating a calibration flow.

FIG. 22 illustrates the first captured image in Step S23 illustrated in FIG. 21.

FIG. 23 illustrates the first captured image in Step S24 illustrated in FIG. 21.

FIG. 24 illustrates the first captured image in Step S24 illustrated in FIG. 21.

FIG. 25 is a view for describing Step S24 illustrated in FIG. 21.

FIG. 26 is a flowchart illustrating a calibration flow according to a fourth embodiment.

FIG. 27 illustrates a hand belonging to a robot.

FIG. 28 illustrates a second captured image in Step S25 illustrated in FIG. 26.

### DESCRIPTION OF EXEMPLARY EMBODIMENTS

Hereinafter, a control device, a robot system, and a control method according to the invention will be described in detail with reference to preferred embodiments illustrated in the accompanying drawings.

### Robot System

### First Embodiment

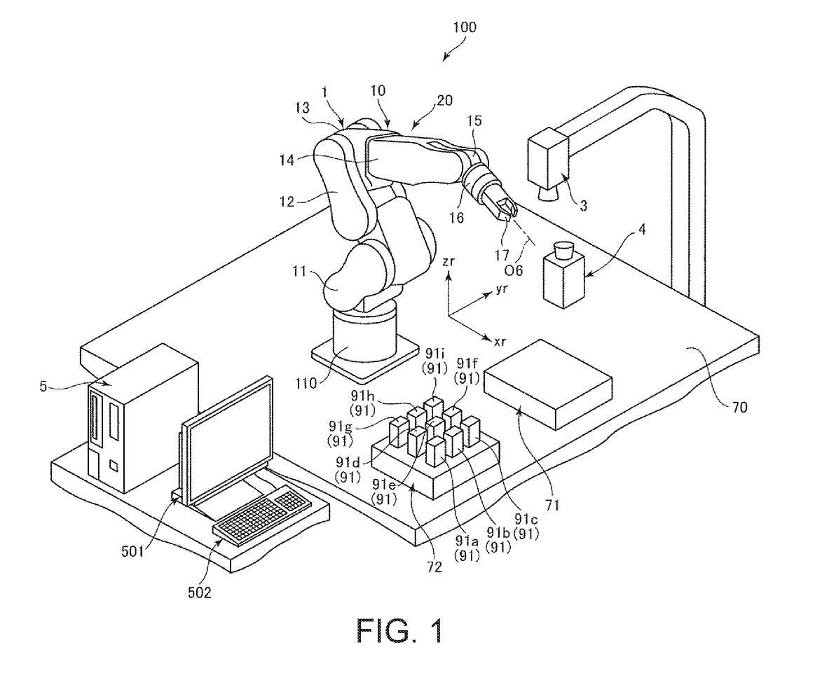

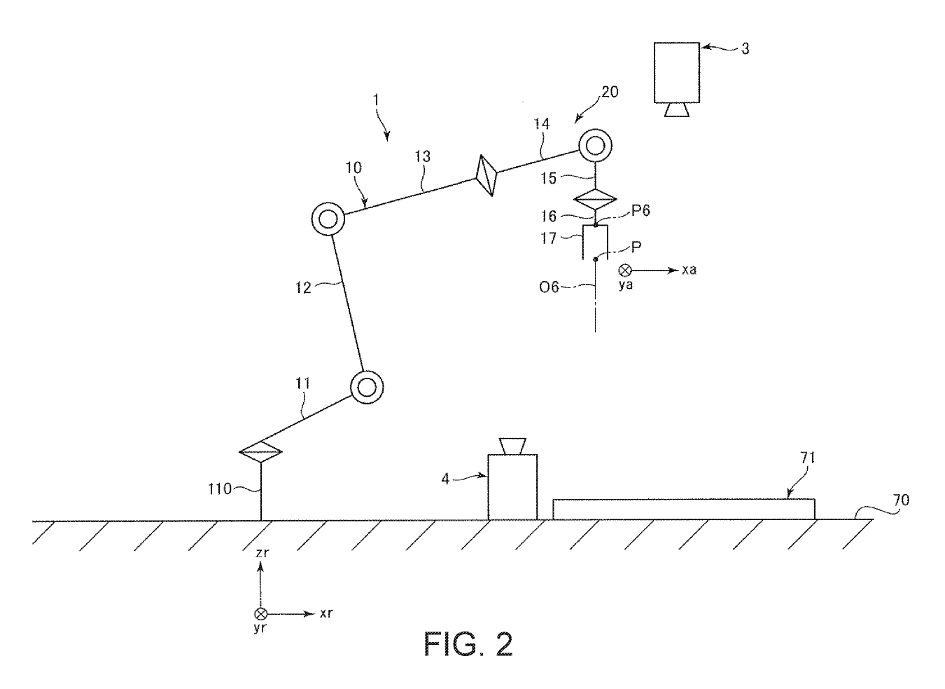

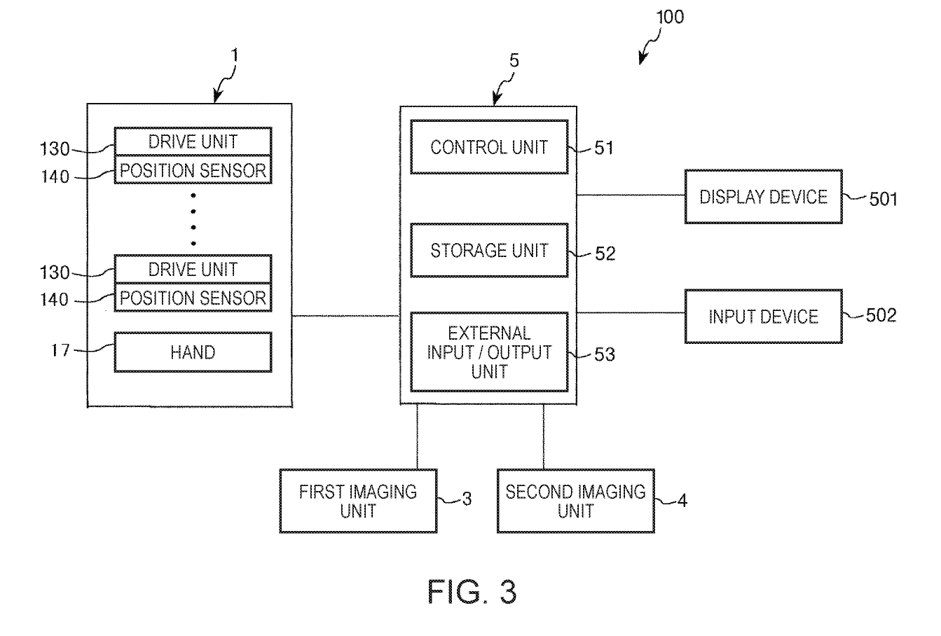

FIG. 1 illustrates a robot system according to a first embodiment. FIG. 2 is a schematic view of the robot system illustrated in FIG. 1. FIG. 3 is a block diagram of the robot system illustrated in FIG. 1. In FIG. 1, three axes orthogonal to each other (an xr-axis, a yr-axis, and a zr-axis) are illustrated. Hereinafter, a direction parallel to the xr-axis will be referred to as an “xr-axis direction”, a direction parallel to the yr-axis will be referred to as a “yr-axis direction”, and a direction parallel to the zr-axis will be referred to as a “zr-axis direction”. Hereinafter, a tip end side of each illustrated arrow will be referred to as “+ (positive)”, and a base end side will be referred to as “− (negative)”. The zr-axis direction coincides with a “vertical direction”, and a direction parallel to an xr-yr plane coincides with a “horizontal direction”. A side of the + (positive) of the zr-axis will be regarded as “upward”, and a side of the − (negative) of the zr-axis will be regarded as “downward”.

In the description herein, the term “horizontal” includes a case of inclination within a range of ±10° or smaller with respect to the horizontal. Similarly, the term “vertical” includes a case of inclination within a range of ±10° or smaller with respect to the vertical. The term “parallel” includes not only a case where two lines (including axes) or planes are perfectly parallel to each other but also a case where the two lines are inclined ±10°. The term “orthogonal” includes not only a case where two lines (including axes) or planes intersect each other at an angle of 90° but also a case where the two lines are inclined within ±10° with respect to 90°.

For example, a robot system 100 illustrated in FIG. 1 can be used for holding, conveying, and assembling a workpiece such as an electronic component. The robot system 100 has a robot 1, a first imaging unit 3 having an imaging function, a second imaging unit 4 having an imaging function, and a control device 5 (calibration device) which controls each drive of the robot 1, the first imaging unit 3, and the second imaging unit 4. The robot system 100 has a display device 501 having a monitor and an input device 502 (operation device) configured to include a keyboard, for example.

Hereinafter, respective units belonging to the robot system 100 will be sequentially described.

### Robot

The robot 1 is a so-called 6-axis vertically articulated robot, and has a base 110 and a movable unit 20 connected to the base 110. The movable unit 20 has a robot arm 10 and a hand 17.

The base 110 allows the robot 1 to be attached to any desired installation place. In this embodiment, the base 110 is installed in an installation place 70 on a floor, for example. The installation place of the base 110 is not limited to the installation place 70 on the floor. For example, the installation place may be a wall, a ceiling, a movable carriage.

As illustrated in FIGS. 1 and 2, the robot arm 10 has an arm 11 (first arm), an arm 12 (second arm), an arm 13 (third arm), an arm 14 (fourth arm), an arm 15 (fifth arm), an arm 16 (sixth arm), and a hand 17 serving as a holding unit. These arms 11 to 16 are connected to one another in this order from a base end side to a tip end side. The respective arms 11 to 16 are pivotable with respect to the adjacent arm or the base 110. The hand 17 has a function to hold a workpiece 91. The workpiece 91 illustrated in FIG. 1 is an example of a “workpiece” such as an electronic component. In this embodiment, a rectangular parallelepiped member is used as an example (refer to FIG. 5).

Here, as illustrated in FIG. 1, the arm 16 has a disk shape, and is pivotable around a pivot axis O6 with respect to the arm 15. As illustrated in FIG. 2, in this embodiment, a center of a tip end surface of the arm 16 will be referred to as a predetermined point P6 (predetermined site). A tip end center of the hand 17, that is, a center of a region between two fingers belonging to the hand 17 will be referred to as a tool center point P.

As illustrated in FIG. 3, the robot 1 has a drive unit 130 including a motor and a speed reducer which causes one arm to pivot with respect to the other arm (or the base 110). For example, as the motor, a servo motor such as an AC servo motor and a DC servo motor can be used. For example, as the speed reducer, a planetary gear type speed reducer or a wave gear device can be used. The robot 1 has a position sensor 140 (angle sensor) for detecting a rotation angle of a rotary shaft of the motor or the speed reducer. For example, as the position sensor 140, a rotary encoder can be used. For example, the drive unit 130 and the position sensor 140 are disposed in the respective arms 11 to 16. In this embodiment, the robot 1 has six drive units 130 and six position sensors 140.

Each of the drive units 130 is electrically connected to a motor driver (not illustrated) incorporated in the base 110 illustrated in FIG. 1. Through the motor driver, each of the drive units 130 is controlled by the control device 5. Each of the position sensors 140 is electrically connected to the control device 5.

The robot 1 configured in this way has a base coordinate system (robot coordinate system) which is set with reference to the base 110 of the robot 1. The base coordinate system is a three-dimensional orthogonal coordinate system defined by the xr-axis and the yr-axis which are respectively parallel to a horizontal direction and the zr-axis which is orthogonal to the horizontal direction and whose vertically upward direction is a positive direction. In this embodiment, in the base coordinate system, a center point on an upper end surface of the base 110 is set as an origin. A translational component with respect to the xr-axis is set as a “component xr”, a translational component with respect to the yr-axis is set as a “component yr”, a translational component with respect to the zr-axis is set as a “component zr”, a rotational component around the zr-axis is set as a “component ur”, a rotational component around the yr-axis is set as a “component vr”, and a rotational component around the xr-axis is set as a “component wr”. A unit of a length (size) of the component xr, the component yr, and the component zr is “mm”, and a unit of an angle (size) of the component ur, the component vr, and the component wr is “°”.

The robot 1 has a tip end coordinate system whose origin is a predetermined point P6 of the arm 16. The tip end coordinate system is a two-dimensional orthogonal coordinate system defined by an xa-axis and a ya-axis which are orthogonal to each other. The xa-axis and the ya-axis are orthogonal to the pivot axis O6. A translational component with respect to the xa-axis is set as a “component xa”, a translational component with respect to the ya-axis is set as a “component ya”, a translational component with respect to the za-axis is set as a “component za”, a rotational component around the za-axis is set as a “component ua”, a rotational component around the ya-axis is set as a “component va”, and a rotational component around the xa-axis is set as a “component wa”. A unit of a length (size) of the component xa, the component ya and the component za is “mm”, and a unit of an angle (size) of the component ua, the component va, and the component wa is “°”. In this embodiment, calibration between the base coordinate system and the tip end coordinate system is completed. In this embodiment, the base coordinate system is regarded as the “robot coordinate system”. However, the tip end coordinate system may be regarded as the “robot coordinate system”.

Hitherto, the configuration of the robot 1 has been briefly described. In this embodiment, as described above, the holding unit is the hand 17. However, the holding unit may adopt any configuration as long as the workpiece can be held. For example, the holding unit may be a device (not illustrated) including a suction mechanism. Although not illustrated, the robot 1 may include a force detection device configured to include a six-axis force sensor for detecting a force (including a moment) applied to the hand 17, for example.

### First Imaging Unit

As illustrated in FIGS. 1 and 2, the first imaging unit 3 is located vertically above the installation place 70 on the floor, and is installed so that an upper surface of a work table 71 can be imaged.

Although not illustrated, for example, the first imaging unit 3 has an imaging element configured to include a charge coupled device (CCD) image sensor having a plurality of pixels, and an optical system including a lens. The first imaging unit 3 causes the lens to form an image on a light receiving surface of the imaging element by using light reflected from an imaging object, converts the light into an electric signal, and outputs the electric signal to the control device 5. The first imaging unit 3 is not limited to the above-described configuration, and may adopt other configurations as long as the configuration has an imaging function.

The first imaging unit 3 has a first image coordinate system, that is, a coordinate system of a captured image output from the first imaging unit 3. The first image coordinate system is a two-dimensional orthogonal coordinate system defined by an xb-axis and a yb-axis which are respectively parallel to an in-plane direction of the captured image (refer to FIG. 10 to be described later). In this embodiment, a translational component with respect to the xb-axis is set as a “component xb”, a translational component with respect to the yb-axis is set as a “component yb”, and a rotational component around a normal line of an xb-yb plane is set as a “component ub”. A unit of a length (size) of the component xb and the component yb is a “pixel”, and a unit of an angle (size) of the component ub is “°”. The first image coordinate system is a two-dimensional orthogonal coordinate system in which a three-dimensional coordinate projected in a camera view field of the first imaging unit 3 is nonlinearly transformed considering optical characteristics (focal length or distortion) of the lens and the number and size of the pixels of the image element.

### Second Imaging Unit

As illustrated in FIGS. 1 and 2, the second imaging unit 4 is a camera disposed on the installation place 70 on the floor, and is installed so as to be capable of capturing an image vertically upward with respect to the second imaging unit 4.

Although not illustrated, for example, the second imaging unit 4 has an imaging element configured to include a charge coupled device (CCD) image sensor having a plurality of pixels, and an optical system including a lens. The second imaging unit 4 causes the lens to form an image on a light receiving surface of the imaging element by using light reflected from an imaging object, converts the light into an electric signal, and outputs the electric signal to the control device 5. The second imaging unit 4 is not limited to the above-described configuration, and may adopt other configurations as long as the configuration has an imaging function.

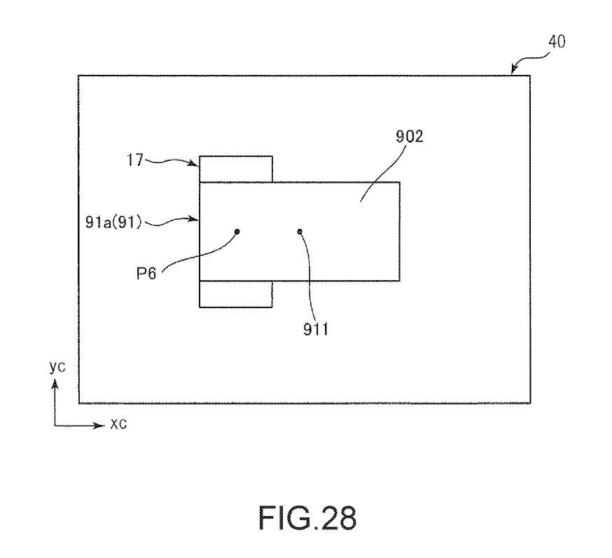

A second image coordinate system, that is, a coordinate system of a second captured image 40 output from the second imaging unit 4 is set in the second imaging unit 4. The second image coordinate system is a two-dimensional orthogonal coordinate system defined by an xc-axis and a yc-axis which are respectively parallel to an in-plane direction of the second captured image 40 (refer to FIG. 28 to be described later). In this embodiment, a translational component with respect to the xc-axis is set as a “component xc”, a translational component with respect to the yc-axis is set as a “component yc”, and a rotational component around a normal line of an xc-yc plane is set as a “component uc”. A unit of a length (size) of the component xc and the component yc is a “pixel”, and a unit of an angle (size) of the component uc is “°”. The image coordinate system of the second imaging unit 4 is a two-dimensional orthogonal coordinate system in which a three-dimensional coordinate projected in a camera view field of the second imaging unit 4 is nonlinearly transformed considering optical characteristics (focal length or distortion) of the lens and the number and size of the pixels of the image element.

### Control Device

The control device 5 illustrated in FIG. 1 controls drive of each unit of the robot 1 and the first imaging unit 3. For example, the control device 5 can be configured to include a personal computer (PC) internally equipped with a processor such as a central processing unit (CPU), a volatile memory such as a read only memory (ROM), and a nonvolatile memory such as a random access memory (RAM). The control device 5 may be connected to each of the robot 1, the first imaging unit 3, and the second imaging unit 4 in a wired or wireless manner. A display device 501 including a monitor (not illustrated) and an input device 502 configured to include a keyboard, for example, are connected to the control device 5.

As illustrated in FIG. 3, the control device 5 has a control unit 51 (processor), a storage unit 52 (memory), and an external input/output unit 53 (I/O interface).

The control unit 51 (processor) executes various programs stored in the storage unit 52. In this manner, each drive of the robot 1, the first imaging unit 3, and the second imaging unit 4 can be controlled, and various calculation and determination processes can be realized.

For example, the storage unit 52 is configured to include the volatile memory or the non-volatile memory. The storage unit 52 is not limited to a configuration where the control device 5 is internally equipped with the storage unit 52 (the volatile memory or the nonvolatile memory), and may adopt a configuration having a so-called external storage device (not illustrated).

The storage unit 52 stores various programs (commands) which can be executed by a processor. The storage unit 52 can store various data items received by the external input/output unit 53.

The various programs include a robot drive command relating to drive of the robot 1, a first coordinate transformation command relating to correlation between the first image coordinate system and the tip end coordinate system of the robot 1 or the robot coordinate system (base coordinate system), a second coordinate transformation command relating to correlation between the second image coordinate system and the tip end coordinate system of the robot 1 or the robot coordinate system (base coordinate system), and a robot coordinate transformation command relating to correlation between the tip end coordinate system and the base coordinate system.

The first coordinate transformation command is a command to obtain a coordinate transformation equation for transforming a first image coordinate (xb, yb, and ub: position and posture) serving as a coordinate in the first image coordinate system into a coordinate (xa, ya, and ua: position and posture) in the tip end coordinate system of the robot 1 or a robot coordinate (xr, yr, and ur: position and posture) serving as a coordinate in the robot coordinate system. The first coordinate transformation command is executed, thereby enabling the correlation among the first image coordinate, the tip end coordinate system, and the robot coordinate system. The second coordinate transformation command is a command to obtain a coordinate transformation equation for transforming a second image coordinate (xc, yc, and uc: position and posture) serving in the second image coordinate system into the coordinate (xa, ya, and ua: position and posture) in the tip end coordinate system of the robot 1 or the robot coordinate. The second coordinate transformation command is executed, thereby enabling the correlation among the second image coordinate, the tip end coordinate system, and the robot coordinate system.

For example, various data items include data output from a plurality of position sensors 140 belonging to the robot 1, data of the captured image output from the first imaging unit 3, and data of the captured image output from the second imaging unit 4. Various data items include data of the number of respective pixels of the first imaging unit 3 and the second imaging unit 4, and data relating to speed or acceleration (more specifically, movement speed and movement acceleration of the hand 17, for example) of the robot 1 when calibration is performed (to be described later).

For example, the external input/output unit 53 is configured to include an I/O interface circuit, and is used for connecting the control device 5 to other respective devices (the robot 1, the first imaging unit 3, the second imaging unit 4, the display device 501, and the input device 502). Therefore, the external input/output unit 53 has a function as a receiving unit which receives various data items output from the robot 1, the first imaging unit 3, and the second imaging unit 4. The external input/output unit 53 has a function to output and display information relating to various screens (for example, an operation screen) on a monitor of the display device 501.

In addition to the above-described configuration, the control device 5 may further include other additional configurations. The control unit 51 may be configured to include a single processor or a plurality of processors. The storage unit 52 and the external input/output unit 53 may be similarly configured.

### Display Device and Input Device

The display device 501 illustrated in FIG. 1 includes a monitor, and has a function to display various screens. Therefore, a worker can confirm the captured image output from the first imaging unit 3, the captured image output from the second imaging unit 4, and the drive of the robot 1 via the display device 501.

For example, the input device 502 is configured to include a keyboard. Therefore, the worker operates the input device 502, thereby enabling the worker to instruct the control device 5 to perform various processes. Although not illustrated, the input device 502 may be configured to include a teaching pendant, for example.

Instead of the display device 501 and the input device 502, a display input device (not illustrated) provided with both functions of the display device 501 and the input device 502 may be used. For example, as the display input device, a touch panel can be used. The robot system 100 may have one display device 501 and one input device 502, or may have a plurality of the display devices 501 and the input devices 502.

Hitherto, a basic configuration of the robot system 100 has been briefly described. The robot system 100 has the control device 5 and the robot 1 controlled by the control device 5. The control device 5 performs control to be described later.

According to the robot system 100 configured in this way, the control can be performed by the control device 5 (to be described later). Accordingly, workability of the robot system 100 operated by the worker can be improved. The robot 1 can more correctly, quickly, and accurately carry out the work on the workpiece 91.

### Control Method

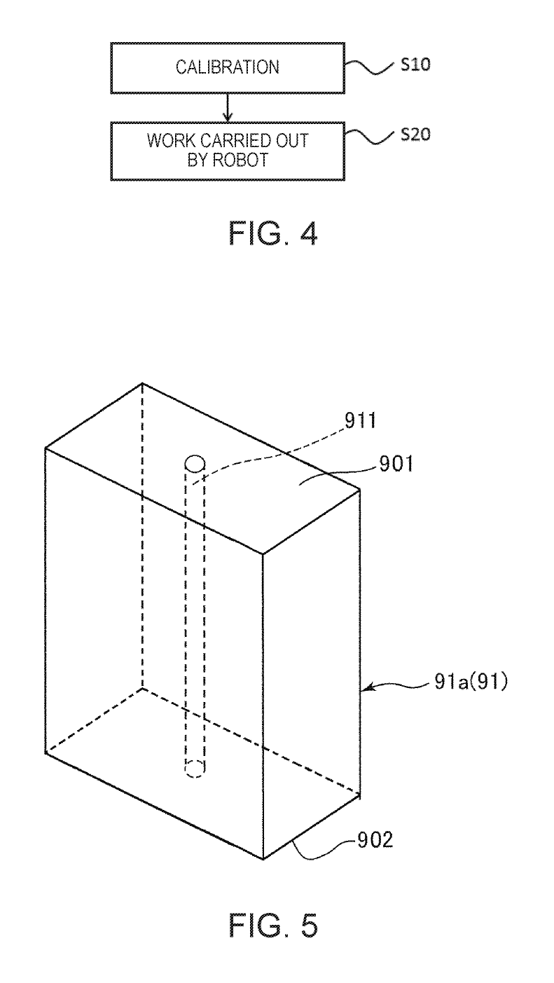

FIG. 4 is a flowchart illustrating a control method of the robot controlled by the control device.

As illustrated in FIG. 4, the control method of the robot 1 controlled by the control device 5 has a calibration step (Step S10) and a work step (Step S20) carried out by the robot 1, based on a result of the calibration step.

Specific work content performed by the robot 1 is not particularly limited. However, in the work (Step S20) carried out by the robot 1, a “workpiece” used in the calibration (Step S10) or “one having a configuration the same as or equivalent to the workpiece” is used. Therefore, in this embodiment, as will be described later, the workpiece 91 illustrated in FIG. 1 is used in the calibration. Accordingly, the work using the workpiece 91 is carried out in the actual work carried out by the robot 1.

The specific work content of the work (Step S20) carried out by the robot 1 is not particularly limited. Therefore, hereinafter, description thereof will be omitted, and the calibration (Step S10) will be described.

### Calibration

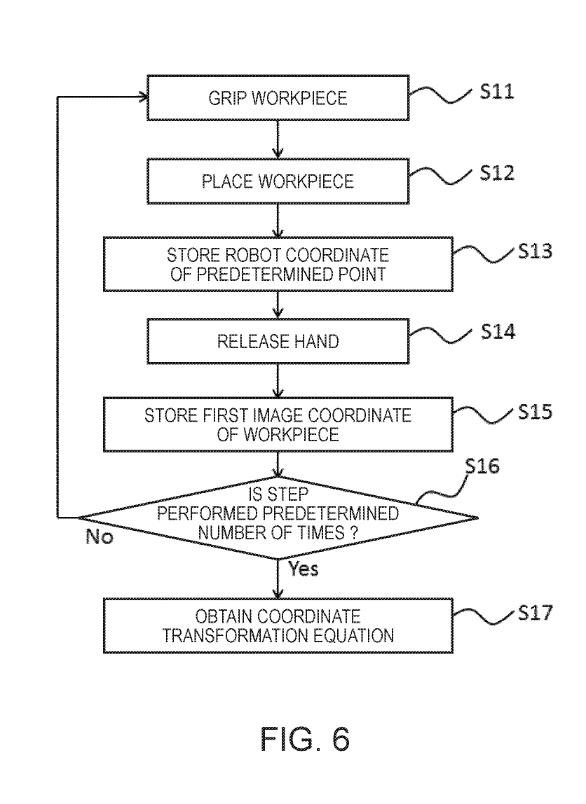

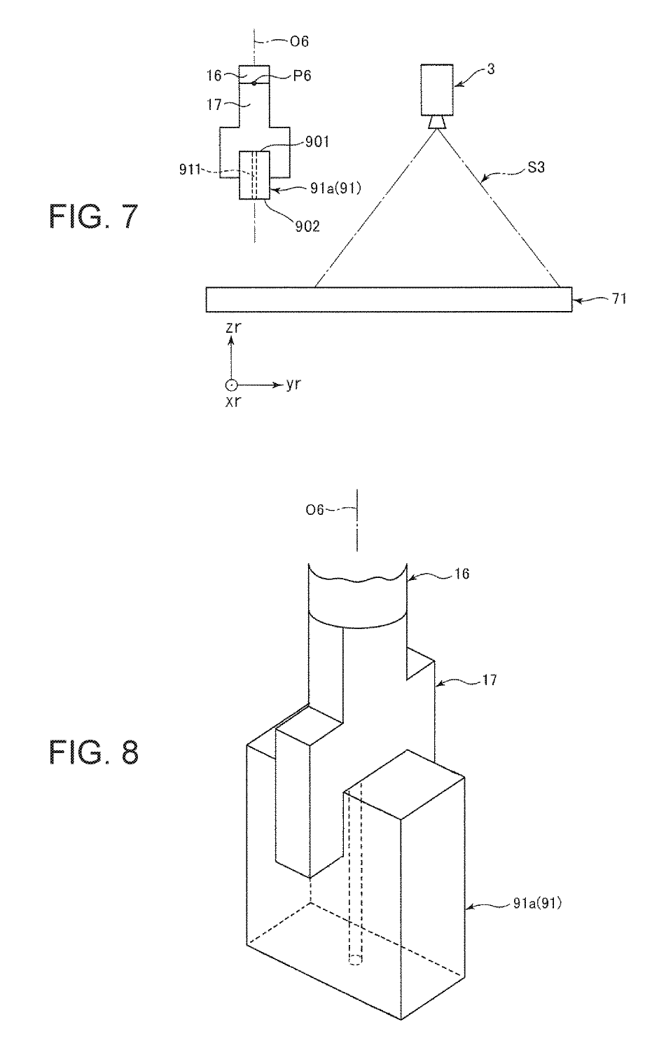

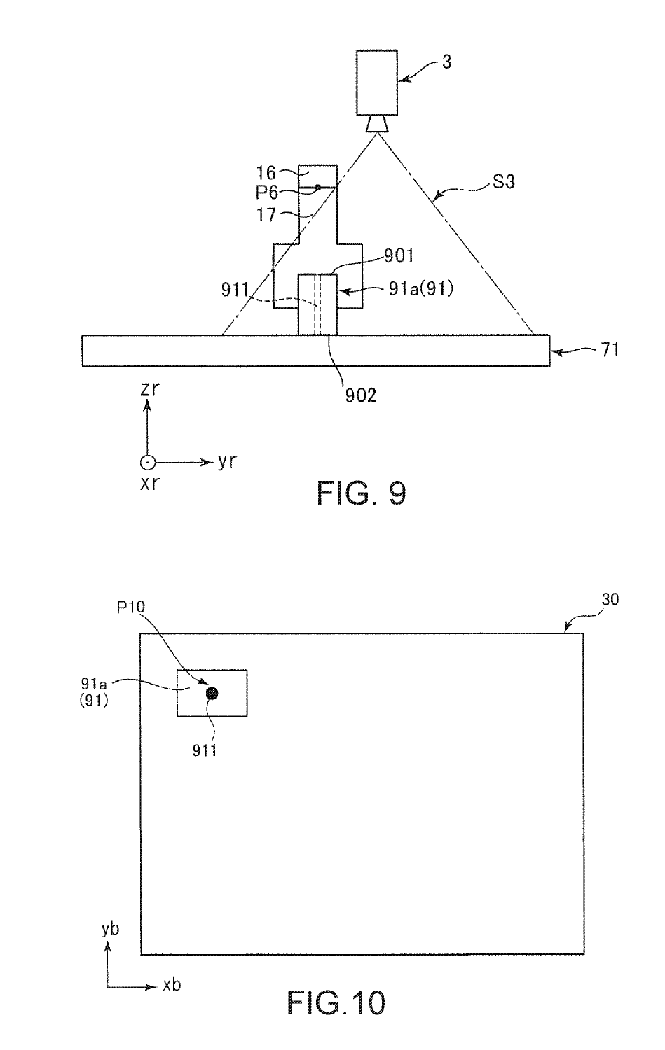

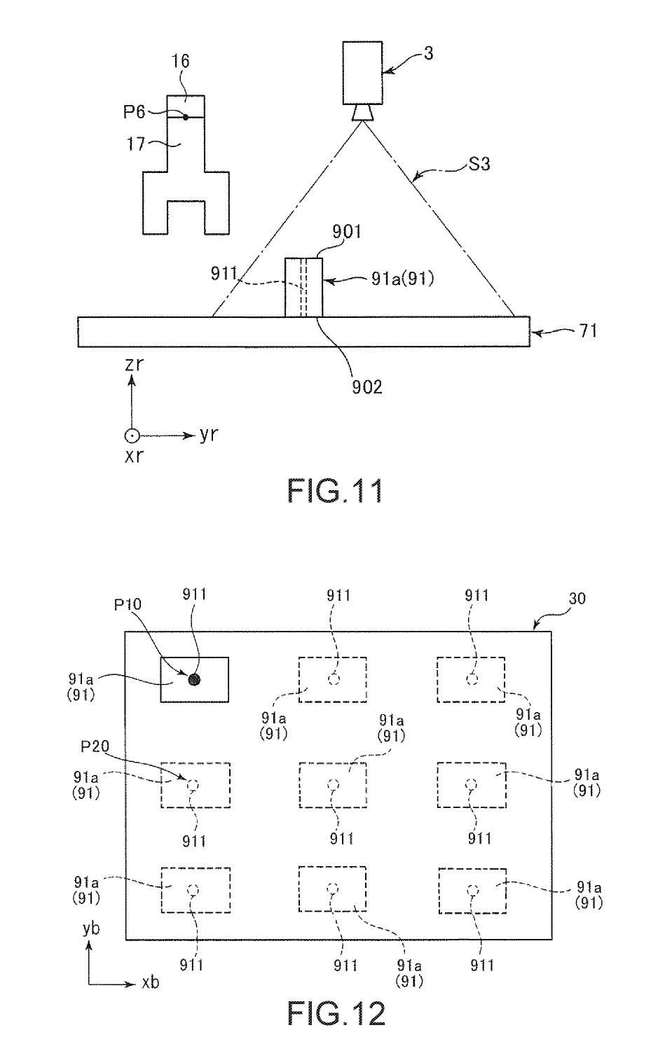

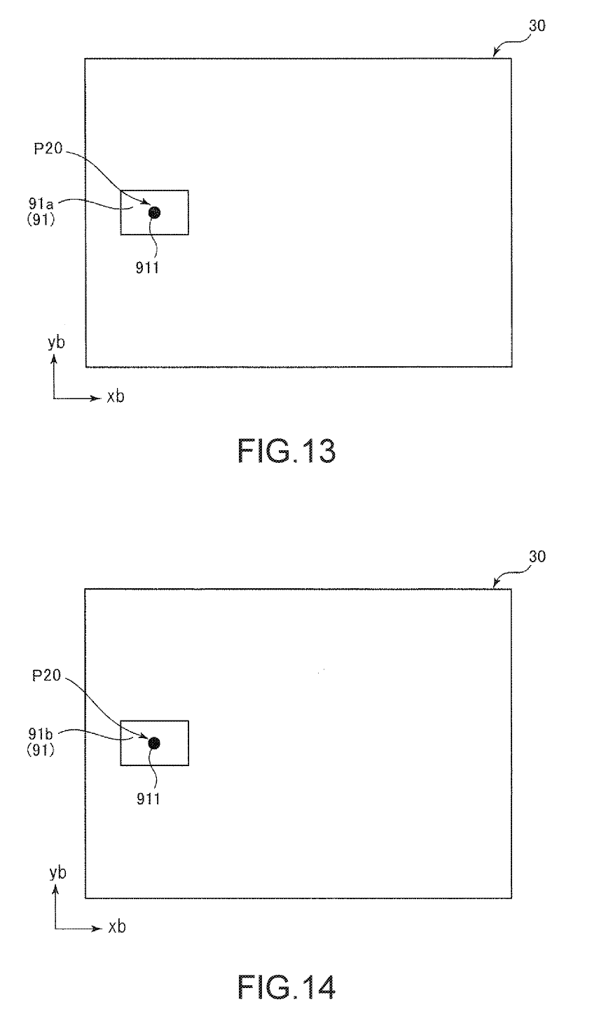

FIG. 5 illustrates an example of a workpiece. FIG. 6 is a flowchart illustrating a calibration flow. FIGS. 7 and 8 are views for respectively describing Step S11 in FIG. 6. FIG. 9 is a view for describing Step S12 in FIG. 6. FIG. 10 illustrates a first captured image. FIG. 11 is a view for describing Step S14 in FIG. 6. FIGS. 12 and 13 illustrate the first captured image.

In the calibration (Step S10), the calibration (correlation) is performed between the first image coordinate system of the first imaging unit 3 and the robot coordinate system of the robot 1. In order to cause the robot 1 to carry out various types of work based on the data of the captured image output from the first imaging unit 3, the robot system 100 obtains a coordinate transformation equation for transforming the coordinate (first image coordinate: xb, yb, and ub) in the first image coordinate system into the coordinate (robot coordinate: xr, yr, and ur) in the robot coordinate system. The correlation can be performed between the first image coordinate system and the robot coordinate system by obtaining the coordinate transformation equation.

In this embodiment, the calibration is performed using the workpiece 91 illustrated in FIGS. 1 and 5. As illustrated in FIG. 5, the workpiece 91 is a rectangular parallelepiped (columnar) member. The workpiece 91 has a through-hole 911 which is open to each of a surface 901 and a surface 902 facing the surface 901 and which extends in a longitudinal direction. The through-hole 911 is formed at the center of the workpiece 91. For example, the through-hole 911 can be used by inserting a rod-shaped member such as a screw into the through-hole 911 in the work (Step S20) carried out by the robot 1. A plurality (nine in the drawing) of the workpieces 91 are placed on a placing table 72. The workpieces 91 are placed and erected in a matrix in the same direction and at the same posture. In the description herein, these are collectively referred to as the workpiece 91. Workpieces 91a to 91i are set to have substantially the same shape (same dimension) and the same weight. The workpieces 91a to 91i represent the “workpiece” on which the robot 1 actually carries out the work, and do not represent a dedicated member for the calibration.

Hereinafter, referring to the flowchart illustrated in FIG. 6, the calibration will be described. The calibration is performed in such a way that the control device 5 causes the control unit 51 to execute a program stored in the storage unit 52 in accordance with an instruction of the worker using the input device 502.

First, the control unit 51 drives the robot arm 10 so as to grip one workpiece 91a out of nine workpieces 91a to 91i by using the hand 17 as illustrated in FIG. 7 (Step S11). This gripping operation is performed using a jog operation, for example. The jog operation means an operation of the robot 1 based on a guidance instruction made by the worker using the input device 502 such as a teaching pendant, for example.

Here, in this embodiment, as illustrated in FIG. 8, the hand 17 has a self-alignment function configured so that the through-hole 911 is located on the pivot axis O6 when the workpiece 91a is gripped. That is, the hand 17 is configured so that a position of the predetermined point P6 and a position of the through-hole 911 are necessarily coincident with each other when viewed in a direction along the pivot axis O6.

Next, the control unit 51 locates the workpiece 91a inside a field of view of the first imaging unit 3, that is, inside an imaging region S3, and places the workpiece 91a on the work table 71 as illustrated in FIG. 9 (Step S12). In this case, for example, as illustrated in FIG. 10, the workpiece 91a is projected on the first captured image 30.

Next, the control unit 51 stores the robot coordinate of the predetermined point P6 in the storage unit 52 (Step S13). In this case, as illustrated in FIG. 9, the hand 17 is not yet released, and is in a state where the workpiece 91a is gripped by the hand 17.

Next, the control unit 51 releases the hand 17, and detaches the hand 17 from the workpiece 91a as illustrated in FIG. 11 (Step S14). In this case, the position of the workpiece 91a is not changed from the position before the hand 17 is released.

Next, the control unit 51 causes the first imaging unit 3 to image the workpiece 91a, and causes the storage unit 52 to store a first image coordinate in the through-hole 911 of the workpiece 91a which is obtained based on the data of the first captured image 30 (Step S15).

Next, the control unit 51 determines whether or not Steps S11 to S15 described above are performed a predetermined number of times (Step S16), and repeats Steps S11 to S15 until the steps are performed the predetermined number of times. In this embodiment, Steps S11 to S15 described above are repeated nine times. In other words, in this embodiment, the control unit 51 repeats Steps S11 to S15 until it is determined that nine pairs of the robot coordinate and the first image coordinate are acquired.

Here, in this embodiment, the control unit 51 moves the workpiece 91a so that the through-hole 911 of the workpiece 91a projected on the first captured image 30 is projected at a different position at each time. In particular, as illustrated in FIG. 12, it is preferable to move the through-hole 911 so as to be located in a lattice shape. Therefore, for example, in Step S12 at first time, in a case where the workpiece 91a is located at an upper left position (first position P10) in FIG. 12 (refer to FIGS. 9 and 12), in Step S12 at second time, the control unit 51 moves the workpiece 91a so that the workpiece 91a is projected at a left center position (second position P20) in FIG. 12. In this way, the control unit 51 repeats Steps S11 to S15 nine times, stores the robot coordinates of the nine predetermined points P6 in the storage unit 52, and stores nine first image coordinates of the workpiece 91a corresponding to each robot coordinate in the storage unit 52.

Next, if the steps are repeated a predetermined number of times (nine in this embodiment), based on the robot coordinate of the nine predetermined points P6 and the first image coordinates of the nine workpieces 91a, the control unit obtains a coordinate transformation equation for transforming the first image coordinate into the robot coordinate (Step S17). In this manner, the calibration (correlation) is completed between the image coordinate system and the robot coordinate system.

Hitherto, the calibration (Step S10) has been briefly described. Here, if the obtained coordinate transformation equation is used, a position and a posture of an imaging target imaged by the first imaging unit 3 can be transformed into a position and a posture in the robot coordinate system. Furthermore, as described above, the correlation is in a completed state between the robot coordinate system (base coordinate system) and the tip end coordinate system. Accordingly, the position and the posture of the imaging target imaged by the first imaging unit 3 can be transformed into the position and the posture in the tip end coordinate system. Therefore, based on the first captured image 30, the control unit 51 can locate the hand 17 of the robot 1 and the workpiece 91a gripped by the hand 17 at a desired place. Therefore, as a result in the calibration (Step S10), the coordinate transformation equation is used for robot coordinate system and the first imaging unit 3, thereby enabling the robot 1 to properly carry out the work in the work (FIG. 4: Step S20) carried out by the robot 1.

As described above, the control device 5 includes the external input/output unit 53 which functions as a receiving unit to receive information relating to the first captured image 30 from the first imaging unit 3 capable of capturing the image, and the control unit 51 which can execute the command relating to the drive of the robot 1 having the movable unit 20 capable of holding the workpiece 91a, based on the information relating to the first captured image 30. The control unit 51 can perform the correlation between the robot coordinate system serving as the coordinate system relating to the robot 1 and the first image coordinate system serving as the coordinate system relating to the first captured image 30. The control unit 51 performs the calibration (correlation), based on the robot coordinate (coordinate in the robot coordinate system) of the predetermined point P6 as the predetermined site of the movable unit 20 holding the workpiece 91a when the workpiece 91a is located at each of the plurality of positions inside the imaging region S3 of the first imaging unit 3, and the first image coordinate (coordinate in the first image coordinate system) of the workpiece 91a when the workpiece 91a is located at each of the plurality of positions.

According to this control device 5, the calibration (correlation) can be performed using the workpiece 91a serving as an actual workpiece of the robot 1. Accordingly, time and labor can be saved in preparing a dedicated member for the calibration in the related art and a more accurate calibration can be performed. In particular, it is not necessary to prepare the dedicated member in view of the height of the workpiece 91a as in the related art. Since the calibration is performed using the workpiece 91a, it is possible to use a design height of the workpiece 91a. Accordingly, the calibration in a height direction (zr-axis direction) can be omitted. In this way, a calibration procedure is simplified, and workability of a worker can be improved. Based on a result (coordinate transformation equation) of the calibration using the workpiece 91a, the robot 1 can carry out various types of work. Therefore, the robot 1 can correctly carry out the work on the workpiece 91a.

In this embodiment, the predetermined point P6 serving as the predetermined site is set. However, the predetermined site may be located at any place of the movable unit 20. For example, the predetermined site may be a tool center point P, or a tip end center of the arm 15. In this embodiment, a place serving as a reference of the workpiece 91a in the calibration is the through-hole 911. However, without being limited thereto, the place serving as the reference may be a corner portion of the workpiece 91a, for example.

As described above, in the calibration (correlation), the control unit 51 obtains a coordinate in the robot coordinate system of the predetermined point P6 serving as the predetermined site in a state where the workpiece 91a is held by the movable unit 20 (Step S13), and detaches the movable unit 20 from the workpiece 91a (Step S14). Thereafter, the control unit 51 obtains a coordinate in the first captured image 30 of the workpiece 91a (Step S15).

In this manner, the calibration can be correctly, quickly, and more accurately (more precisely) performed. The calibration can be performed using only the first imaging unit 3 (one imaging unit) with which the robot 1 actually carries out the work. Therefore, the workability is more satisfactory to the worker.

Furthermore, as described above, the first imaging unit 3 is installed so as to be capable of imaging the work table 71. The external input/output unit 53 having a function as the receiving unit can communicate with the first imaging unit 3 disposed so as to be capable of imaging the work table 71 on which the workpiece 91a is placed.

In this manner, the workpiece 91a placed on the work table 71 can be imaged, and the calibration can be correctly performed using the first captured image 30 obtained by imaging the workpiece 91a. Furthermore, when the robot 1 carries out on the workpiece 91a and the workpieces 91b to 91i having the same configuration, based on a result of the calibration, the control unit 51 enables the robot 1 to properly carry out the work by using the first captured image 30. In this way, the calibration can be performed using only the first imaging unit 3 (one imaging unit), and the actual work can be carried out by the robot 1. Therefore, the workability is very satisfactory to the worker.

As described above, in the calibration (correlation), the control unit 51 uses the first captured image 30 captured when the workpiece 91a is located at a first position P10 inside the imaging region S3, and the first captured image 30 captured when the workpiece 91a is located at a second position P20 which is different from the first position P10 inside the imaging region S3 (refer to FIG. 12).

In this manner, if only one workpiece 91a is used, the calibration can be performed. The calibration can be quickly, easily, and more accurately performed using one first imaging unit 3. Therefore, it is possible to save time and labor of the worker can be saved.

The first position P10 and the second position P20 are not limited to the illustrated positions. As long as the positions are different from each other, both the positions are not limited to the positions respectively illustrated in FIG. 12.

Here, in the above description, the control unit 51 performed the calibration using one workpiece 91a. However, the calibration can also be performed using a plurality of the workpieces 91a to 91i (refer to FIG. 1). Hereinafter, this example will be described.

### First Example of Calibration Using Plurality of Workpieces

FIG. 14 illustrates the first captured image.

In the calibration using a plurality of the workpieces 91a to 91i, for example, the workpiece 91a serving as a first workpiece is located at the first position P10 (refer to FIG. 10), and the workpiece 91b serving as a second workpiece is located at the second position P20 (refer to FIG. 14). That is, in Steps S11 to S15 at the first time, the processes are performed using the workpiece 91a, and in Steps S11 to S15 at the second time, the processes are performed using the workpiece 91b.

In this way, the workpiece 91 includes the workpiece 91a (first workpiece) and the workpiece 91b (second workpiece) different from the workpiece 91a. In the calibration (correlation), the control unit 51 uses the first captured image 30 captured when the workpiece 91a is located at the first position P10 inside the imaging region S3, and the first captured image 30 captured when the workpiece 91b is located at the second position P20 different from the first position P10 inside the imaging region S3. In this embodiment, the control unit 51 uses each of the first captured images 30 when the different workpieces 91a to 91i are located at nine respective positions.

In this way, the calibration can be performed using a plurality of the workpieces 91a to 91i. According to this method, time and labor can also be saved in using a dedicated member for the calibration.

### Second Example of Calibration Using Plurality of Workpieces

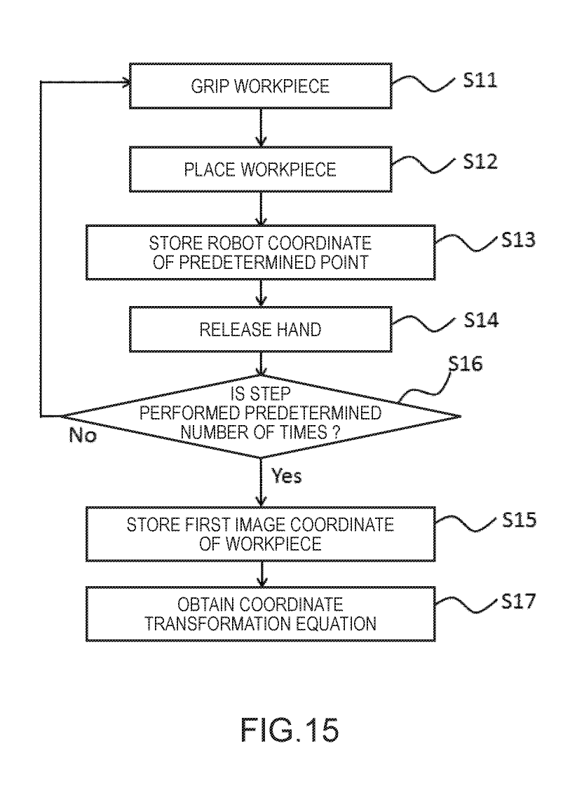

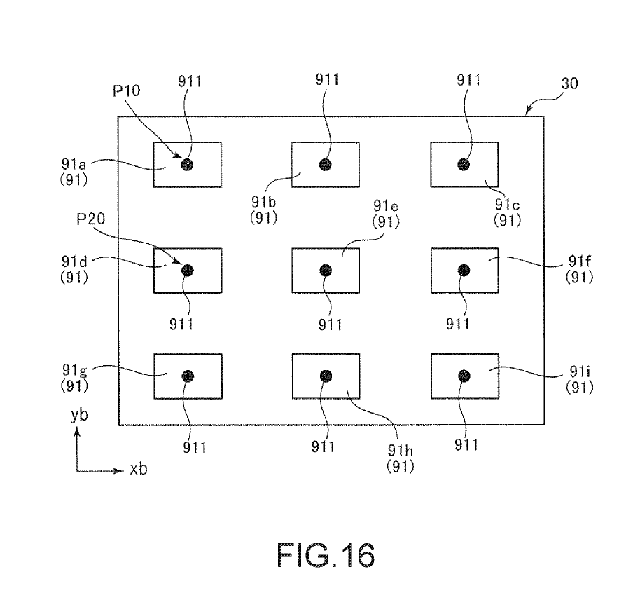

FIG. 15 is a flowchart illustrating an example of the calibration using a plurality of workpieces. FIG. 16 illustrates the first captured image.

For example, the control unit 51 locates the different workpiece 91a to 91i at each of any desired nine positions. Thereafter, the control unit 51 causes the first imaging unit 3 to collectively image the workpiece 91a to 91i. That is, as illustrated in FIG. 15, Step S15 is performed after Step S16.

In this way, the workpiece 91 includes the workpiece 91a (first workpiece) and the workpiece 91b (second workpiece) different from the workpiece 91a. In the calibration (correlation), the control unit 51 uses the first captured image 30 captured when the workpiece 91a is located at the first position P10 inside the imaging region S3 and the workpiece 91b is located at the second position P20 different from the first position P10 inside the imaging region S3. In this embodiment, the different workpiece 91a to 91i are respectively located at the nine positions. Thereafter, the control unit 51 uses the first captured image 30 obtained by collectively imaging the nine workpieces 91a to 91i (refer to FIG. 16).

In this manner, the calibration can be more quickly performed, compared to a case of using the first captured image 30 captured for each of the above-described positions.

As described above, a control method using the control device 5 includes Step S10 for performing the calibration (correlation) between the robot coordinate system serving as the coordinate system relating to the robot 1 having the movable unit 20 capable of holding the workpiece 91 and the first image coordinate system serving as the coordinate system relating to the first captured image 30 received from the first imaging unit 3 capable of capturing the image, and Step S20 for driving the robot 1, based on the result of the calibration and the information relating to the first captured image 30 which is received from the first imaging unit 3. In Step S10 for performing the calibration, the calibration (correlation) is performed, based on the coordinate in the robot coordinate system of the predetermined point P6 serving as the predetermined site of the movable unit 20 holding the workpiece 91 when the workpieces 91 is located at each of the plurality of positions inside the imaging region S3 of the first imaging unit 3, and the coordinate in the first image coordinate system of the workpiece 91 when the workpiece 91 is located at each of the plurality of positions.

According to this control method, as described above, the control method is performed based on the calibration result using the workpiece 91. Therefore, the robot 1 can correctly, quickly, and accurately carried out on the workpiece 91.

Hitherto, the control method has been described. In this embodiment, as illustrated in FIG. 4, the robot 1 carries out the work (Step S20) after the calibration is performed (Step S10). However, if the calibration result is used in Step S20, Step S20 may be performed alone. Alternatively, the calibration (Step S10) may be performed alone.

In this embodiment, the workpiece 91 having the configuration illustrated in FIG. 5 is used. However, the configuration of the “workpiece” is not limited to that illustrated in the drawings. The “workpiece” may adopt a configuration the same as or equivalent to the configuration in which the workpiece can be held by the movable unit 20 and can be used for the work (Step S20) carried out by the robot 1.

### Second Embodiment

Next, a second embodiment will be described.

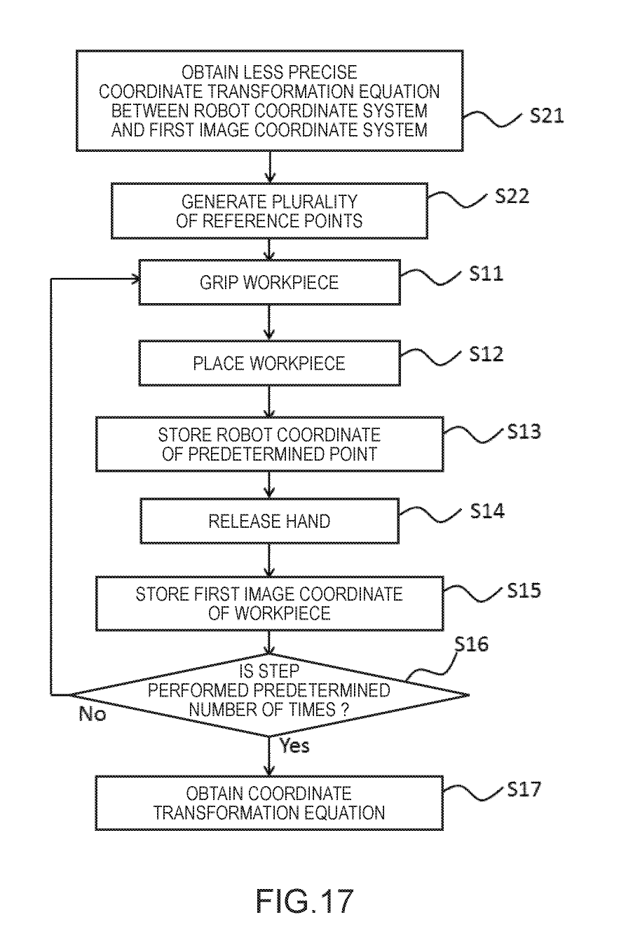

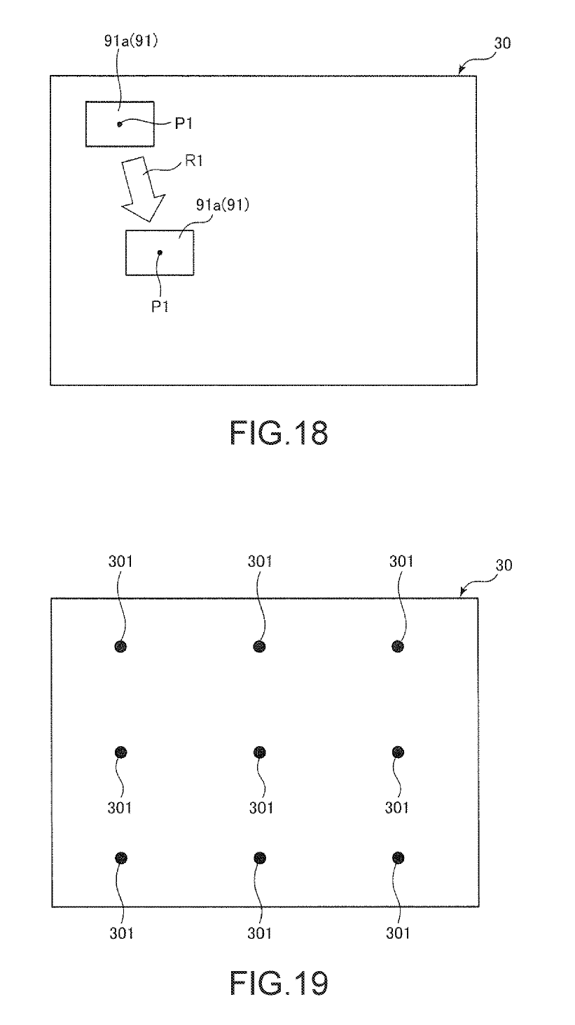

FIG. 17 is a flowchart illustrating a calibration flow according to the second embodiment. FIG. 18 illustrates the first captured image in Step S21 illustrated in FIG. 17. FIG. 19 illustrates the first captured image in Step S22 illustrated in FIG. 17.

This embodiment is mainly the same as the above-described embodiment except that a coordinate transformation equation with low precision is obtained so that Steps S11 to S16 are automatically performed. In the following description, points different from those according to the above-described embodiment will be mainly described, and description of similar matters will be omitted.

Hereinafter, referring to the flowchart illustrated in FIG. 17, the calibration according to this embodiment will be described.

First, the control unit 51 obtains the coordinate transformation equation between the base coordinate system and the first image coordinate system (FIG. 17: Step S21). The coordinate transformation equation obtained in Step S21 is less precise than the coordinate transformation equation obtained in Step S17, and is obtained in order to roughly understand the robot coordinate at a designated position in the first captured image 30.

Specifically, the coordinate transformation equation in Step S21 can be generated through a process of moving the workpiece 91a to any desired two places inside a field of view of the first imaging unit 3.

More specifically, in Step S21, the control unit 51 first causes the hand 17 to grip the workpiece 91a, and moves the workpiece 91a to any two different desired positions so as to acquire two pairs of a robot coordinate (xr and yr) of the predetermined point P6 and a first image coordinate (xb and yb). For example, as illustrated in FIG. 18, the workpiece 91a is moved in a direction of an arrow R1 so as to respectively acquire the robot coordinate (xr and yr) of the predetermined point P6 at two places before and after the movement and the first image coordinate (xb and yb). Next, the control unit 51 obtains coefficients a, b, c, and d in Equation (1) below, based on the robot coordinate (xr and yr) of the two predetermined points P6 and the first image coordinates (xb and yb) of the two workpieces 91a. In this manner, the coordinate transformation equation can be obtained between the robot coordinate and the first image coordinate.

$$( \begin{matrix}xb \\ yb\end{matrix} ) = ( \begin{matrix}a & b \\ c & d\end{matrix} ) ( \begin{matrix}xr \\ yr\end{matrix} ) \qquad ( 1 )$$

Next, nine reference points 301 are set in the first captured image 30 as illustrated in FIG. 19 (Step S22). In this embodiment, the nine reference points 301 arrayed in a lattice shape are set. For example, a search window of the first captured image 30 is divided into nine, and a center of each divided region is set as a reference point 301. In this embodiment, the search window and the first captured image 30 coincide with each other.

If the nine reference points 301 are set, based on the coordinate transformation equation obtained in Step S21 described above, the control unit 51 moves the workpiece 91a so that the through-hole 911 is located at the nine reference points 301. Since the coordinate transformation equation obtained in Step S21 described above is used, the robot coordinate at the designated position inside the first captured image 30 is recognized. Accordingly, a jog operation based on a command of the worker can be omitted. Therefore, Steps S11 to S16 can be automatically performed.

According to the method described above, Steps S11 to S16 can be automatically performed. Accordingly, time and labor can be further saved in the calibration. The nine reference points 301 can be set at a substantially equal interval. Therefore, calibration accuracy can be improved compared to a case where the workpiece 91a is located at any desired nine positions by performing the jog operation based on the command of the worker.

In this embodiment, the nine reference points 301 are provided. However, the number of the reference points 301 is optionally determined, and may be two or more. However, if the number of the reference points 301 increases, the calibration accuracy is improved. In this embodiment, the reference points 301 are arrayed in the lattice shape. However, the array is not limited to the lattice shape.

In this embodiment described above, an advantageous effect the same as that of the first embodiment can also be achieved.

### Third Embodiment

Next, a third embodiment will be described.

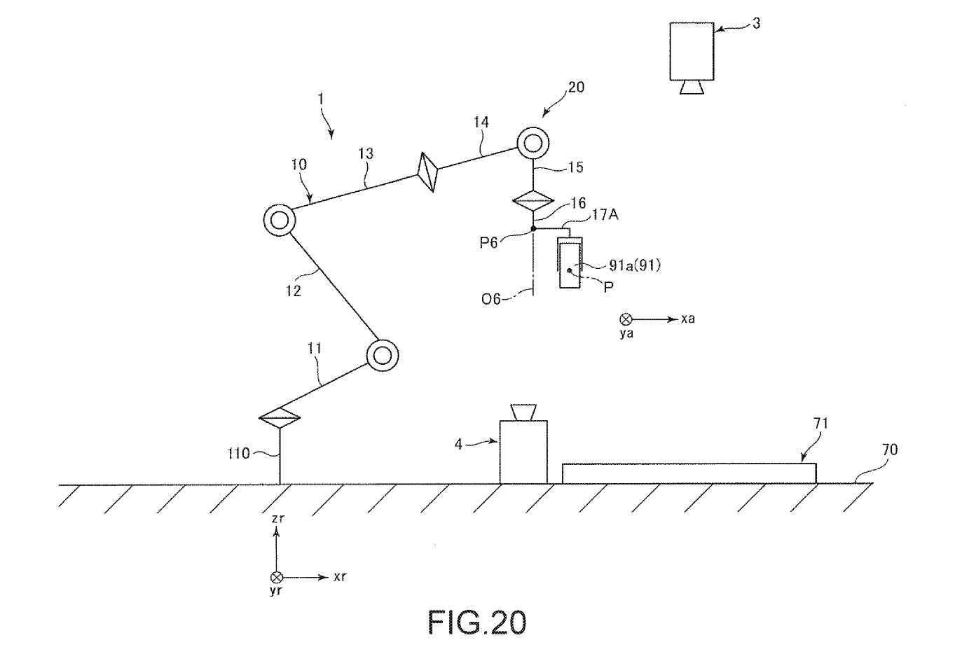

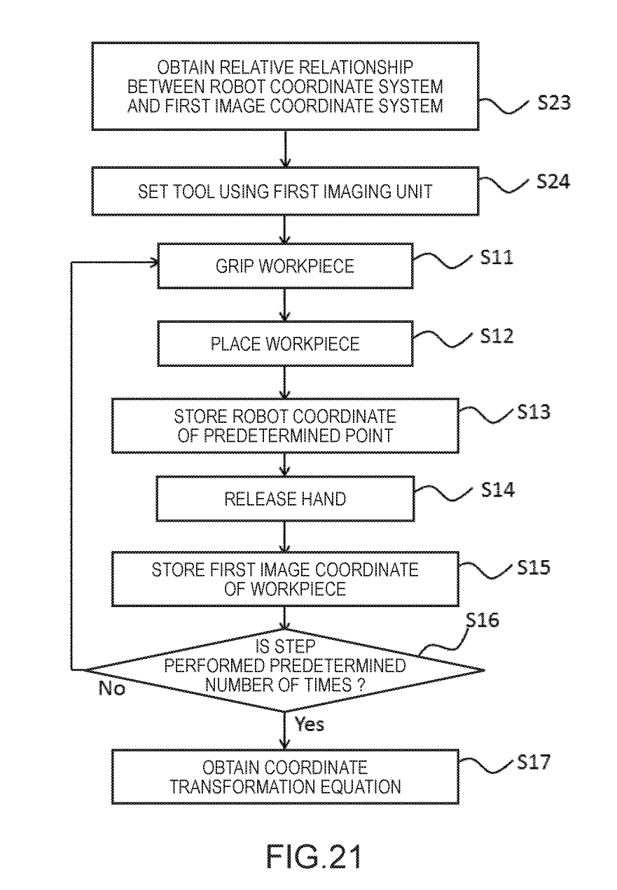

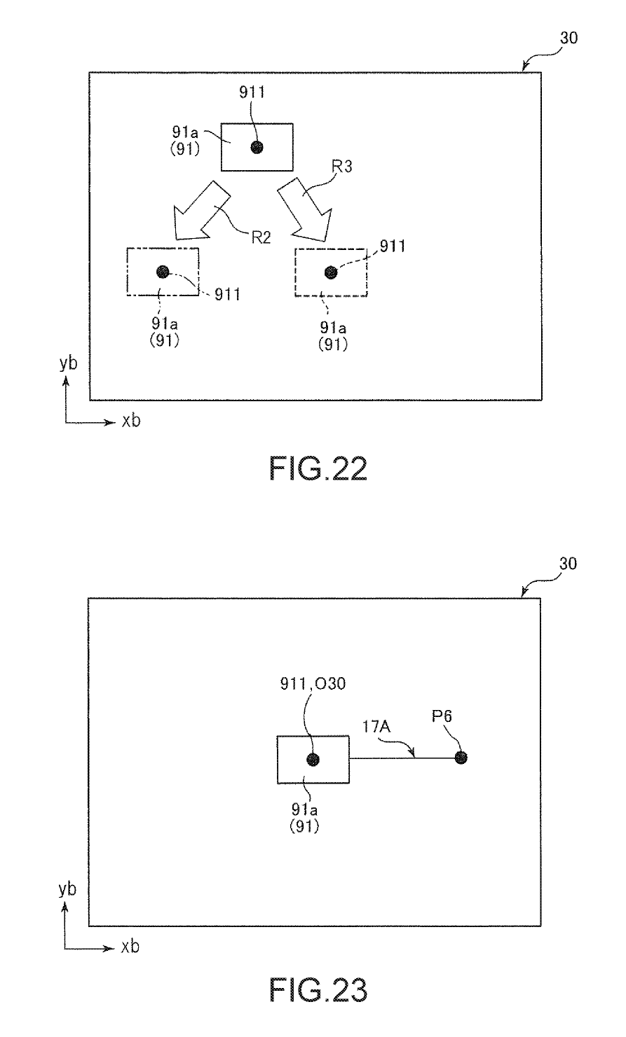

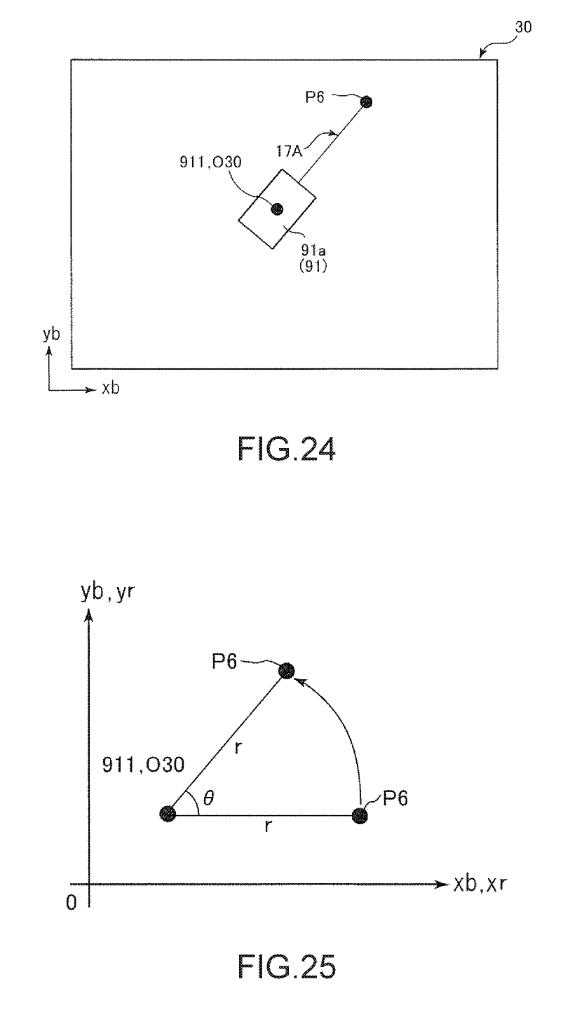

FIG. 20 illustrates a robot system according to a third embodiment. FIG. 21 is a flowchart illustrating a calibration flow. FIG. 22 illustrates the first captured image in Step S23 illustrated in FIG. 21. FIGS. 23 and 24 respectively illustrate the first captured image in Step S24 illustrated in FIG. 21. FIG. 25 is a view for describing Step S24 illustrated in FIG. 21. In FIGS. 23 and 24, for convenience of description, a hand 17A is schematically illustrated, and the predetermined point P6 is illustrated by omitting the illustration of the arm 16.

This embodiment is mainly the same as the above-described embodiments except that a designated position of the workpiece is set using the first imaging unit (tool setting). In the following description, points different from those according to the above-described embodiments will be mainly described, and description of similar matters will be omitted.

As illustrated in FIG. 20, the hand 17A belonging to the robot 1 in this embodiment is disposed at a position shifted from the arm 16. Specifically, the tool center point P of the hand 17A does not coincide with the predetermined point P6 when viewed in a direction along the pivot axis O6. In a case where the calibration is performed using the robot 1 having the hand 17A, as illustrated in FIG. 21, it is preferable to set the designated position of the workpiece 91a by using the first imaging unit (tool setting) before Steps S11 to S16 are performed. In this manner, a position of the tool center point P with respect to the predetermined point P6 or a position of the through-hole 911 of the workpiece 91a is recognized.

Hereinafter, referring to the flowchart illustrated in FIG. 21, the calibration in this embodiment will be described.

First, before Step S11 described above is performed, the control unit 51 obtains a relative relationship between the robot coordinate system and the first image coordinate system (Step S23). Specifically, the control unit 51 locates the workpiece 91a inside the first captured image 30 as indicated by a solid line in FIG. 22 so as to acquire a robot coordinate (xr0 and yr0) of the predetermined point P6 and a first image coordinate (xb0 and yb0) of the through-hole 911 at this time. Next, the control unit 51 moves the workpiece 91a in a direction of an arrow R2, and locates the workpiece 91a as indicated by a two-dot chain line in FIG. 22 so as to acquire a robot coordinate (xr1 and yr1) of the predetermined point P6 and a first image coordinate (xb1 and yb1) of the through-hole 911. In addition, the control unit 51 moves the workpiece 91a in a direction of an arrow R3, and locates the workpiece 91a as indicated by a broken line in FIG. 22 so as to acquire a robot coordinate (xr2 and yr2) of the predetermined point P6 and a first image coordinate (xb2 and yb2) of the through-hole 911.

As described above, the workpiece 91a is moved to three places inside the first captured image 30. However, these locations are optionally set as long as the workpiece 91a is located inside the first captured image 30.

Next, the control unit 51 obtains coefficients a, b, c, and d in Equation (2) below, based on the acquired three robot coordinates and three first image coordinates. In this manner, the coordinate transformation equation can be obtained between the robot coordinate and the first image coordinate. Therefore, the amount of displacement (amount of movement) in the first image coordinate system can be transformed into the amount of displacement in the robot coordinate system (base coordinate system), and furthermore, can be transformed into the amount of displacement in the tip end coordinate system.

$$( \begin{matrix}Δ xb \\ Δ yb\end{matrix} ) = ( \begin{matrix}a & b \\ c & d\end{matrix} ) ( \begin{matrix}Δ xr \\ Δ yr\end{matrix} ) \qquad ( 2 )$$

The reference numerals Δxb and Δyb in Equation (2) represent the displacement (distance) between two places in the image coordinate system, and the reference numerals Δxa and Δya represent the displacement between two places in the robot coordinate system.

In this way, based on the three robot coordinates and the three image coordinates which are obtained by moving the predetermined point P6 to three different places, the coordinate transformation equation (affine transformation equation) indicated by Equation (2) above is used. Accordingly, a relative relationship between the robot coordinate system and the image coordinate system can be easily and properly obtained.

Next, the through-hole 911 (designated position) of the workpiece 91a is set using the first imaging unit 3 (Step S24).

Specifically, the control unit 51 uses the coordinate transformation equation obtained in Step S23, and locates the through-hole 911 of the workpiece 91a at a center O30 of the first captured image 30 as illustrated in FIG. 23 so as to acquire the robot coordinate of the predetermined point P6 and the first image coordinate at this time. Next, as illustrated in FIG. 24, the control unit 51 moves the predetermined point P6 while locating the through-hole 911 of the workpiece 91a at the center O30 of the first captured image 30, and acquires the coordinate in the robot coordinate system of the predetermined point P6 after movement and the coordinate in the image coordinate system.

Next, as illustrated in FIG. 25, the control unit 51 obtains the coordinate in the robot coordinate system of the through-hole 911 with respect to the predetermined point P6, based on the coordinate in the robot coordinate system of the predetermined point P6 before and after the movement and the coordinate in the image coordinate system, a movement angle θ (rotation angle of the predetermined point P6 centered on the through-hole 911), and the coordinate in the image coordinate system of the center O30. In this way, a position (coordinate in the robot coordinate system) of the through-hole 911 can be set with respect to the predetermined point P6.

After Steps S23 and S24 described above are performed, the control unit 51 performs Steps S11 to S17. In this manner, the control unit 51 can properly and easily perform the correlation between the first image coordinate system and the robot coordinate system, even in a state where the position of the workpiece 91a with respect to the predetermined point P6 is not recognized.

In a case where the position of the tool center point P with respect to the predetermined point P6 can be obtained from a design value or a measured value, Step S23 described above may be omitted. In Step S24, without performing the above-described method, the design value or the measured value may be used as the position of the tool center point P (and the position of the through-hole 911) with respect to the predetermined point P6.

In this embodiment described above, an advantageous effect the same as that of the first embodiment can also be achieved.

### Fourth Embodiment

Next, a fourth embodiment will be described.

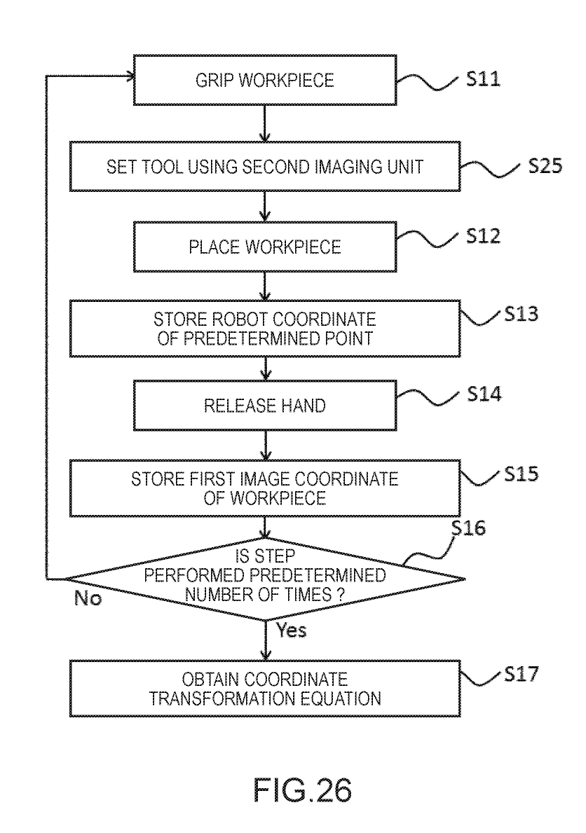

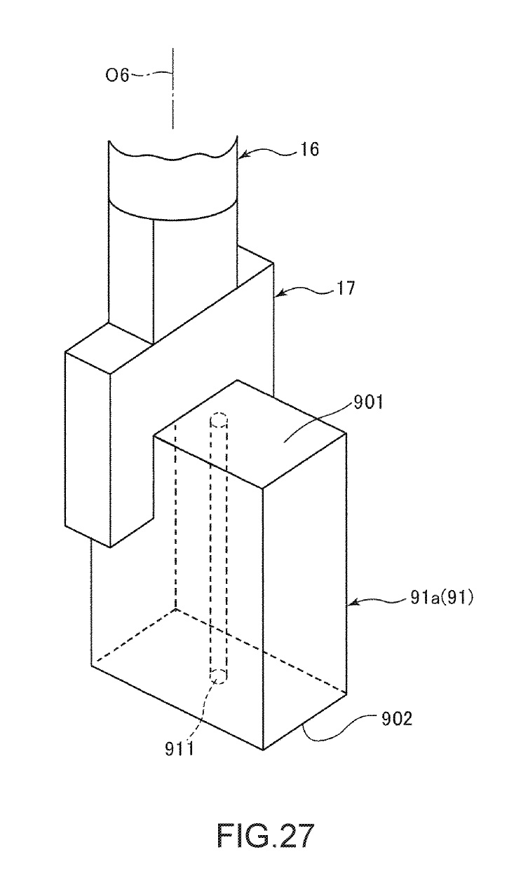

FIG. 26 is a flow chart illustrating a calibration flow according to a fourth embodiment. FIG. 27 illustrates the hand belonging to the robot. FIG. 28 illustrates a second captured image in Step S25 illustrated in FIG. 26.

This embodiment is mainly the same as the above-described embodiments except that a designated position of the workpiece is set using the second imaging unit (tool setting). In the following description, points different from those according to the above-described embodiments will be mainly described, and description of similar matters will be omitted.

The calibration illustrated in FIG. 26 is effectively used in a case where the hand 17 does not have a self-alignment function. The hand 17 which does not have the self-alignment function is not configured so that the through-hole 911 is necessarily located on the pivot axis O6 when the hand 17 grips the workpiece 91a. Therefore, in some cases, as illustrated in FIG. 8, the hand 17 may grip the workpiece 91a so that the through-hole 911 is located on the pivot axis O6, or as illustrated in FIG. 27, the hand 17 may grip the workpiece 91a in a state where the through-hole 911 is not located on the pivot axis O6.

In a case of using the hand 17 in this way, as illustrated in FIG. 26, after the workpiece 91 is gripped (Step S11), before the workpiece 91a is placed (Step S12), the through-hole 911 (designated position) of the workpiece 91a is set using the second imaging unit 4 (step S25). In this embodiment, the designated position of the workpiece 91a is the position of the through-hole 911.

In setting the through-hole 911 (designated position) of the workpiece 91a (Step S25), in a state where the hand 17 grips the workpiece 91a, the control unit 51 locates the workpiece 91a immediately above the second imaging unit 4. In this case, for example, in a case where the workpiece 91a is gripped by the hand 17 as illustrated in FIG. 27, the workpiece 91a is projected onto the second captured image 40 as illustrated in FIG. 28. Here, in the robot system 100, as described in the first embodiment, the correlation is completed between the robot coordinate system and the second image coordinate system. Therefore, the workpiece 91a is located immediately above the second imaging unit 4, and the workpiece 91a is imaged using the second imaging unit 4, thereby recognizing the robot coordinate of the through-hole 911 of the workpiece 91a with respect to the predetermined point P6. In this way, the position (robot coordinate) of the through-hole 911 with respect to the predetermined point P6 can be set. The position of the through-hole 911 (the tool setting) with respect to the predetermined point P6 may be set using a method other than the above-described method. For example, there is a tool setting method as follows (method of using the second imaging unit 4 as illustrated in FIG. 25). While the through-hole 911 is located at an image center of the second captured image 40 of the second imaging unit 4, the workpiece 91a is moved using two different postures.

In the calibration according to this embodiment, as described above, the external input/output unit 53 having a function as the receiving unit can receive the information relating to the second captured image 40 from the second imaging unit 4 capable of capturing the image and different from the first imaging unit 3. The control unit 51 can perform the coordinate transformation between the robot coordinate system and the second image coordinate system serving as the coordinate system relating to the second captured image 40. Based on the coordinate transformation, the control unit 51 can obtain the position of the workpiece 91a (particularly, the through-hole 911) with respect to the predetermined point P6 serving as the predetermined site.

In this manner, even in a state where the position of the workpiece 91a with respect to the predetermined point P6 is not recognized, the calibration (correlation) can be properly and easily performed between the first image coordinate system and the robot coordinate system.

Furthermore, as described above, the second imaging unit 4 is installed so as to be capable of imaging the workpiece 91a in a state where the workpiece 91a is held by the movable unit 20. In particular, the imaging direction of the second imaging unit 4 is opposite to the imaging direction of the first imaging unit 3. The second imaging unit 4 is capable of capturing the image vertically upward with respect to the second imaging unit 4. The first imaging unit 3 is capable of capturing the image vertically downward with respect to the first imaging unit 3. The external input/output unit 53 having the function as the receiving unit can communicate with the second imaging unit 4 disposed so as to be capable of imaging the workpiece 91a in a state where the workpiece 91a is held by the movable unit 20.

In this manner, the position of the workpiece 91a with respect to the predetermined point P6 can be efficiently obtained.

Here, as described in the first embodiment, the configuration of the “workpiece” is not limited to the configuration illustrated in FIG. 5, and is optionally determined. However, in a case where the calibration is performed using the first imaging unit 3 and the second imaging unit 4 as in this embodiment, it is preferable that the place serving as the reference of the calibration of the workpiece 91a is provided for each of a portion which can be imaged by the first imaging unit 3 and a portion which can be imaged by the second imaging unit 4. That is, it is preferable that the place is provided on both a surface 901 and a surface 902 of the workpiece 91a (refer to FIG. 5). It is preferable that the place serving as the reference of the calibration which is provided on the surface 901 and the place serving as the reference of the calibration which is provided on the surface 902 coincide with each other when viewed in the zr-axis direction. In this embodiment, the through-hole 911 functions as both the place serving as the reference of the calibration which is provided on the surface 901 and the place serving as the reference of the calibration which is provided on the surface 902. Since the workpiece 91a having this configuration is used, the calibration can be efficiently performed using the first imaging unit 3 and the second imaging unit 4 which are described above.

In this embodiment described above, an advantageous effect the same as that of the first embodiment can also be achieved.

Hitherto, the control device, the robot system, and the control method according to the invention have been described with reference to the illustrated embodiments. However, the invention is not limited to these embodiments. The configuration of each unit can be substituted with any desired configuration having the same function. Any other configuration element may be added to the invention. The respective embodiments may be appropriately combined with each other.

In the embodiments described above, as an example of the robot belonging to the robot system according to the invention, a so-called six-axis vertically articulated robot has been described. However, the robot may be other robots such as a scalar robot. Without being limited to a single arm robot, for example, another robot such as a double arm robot may be used. Therefore, the number of the movable units is not limited to one, and may be two or more. The number of the arms belonging the robot arm included in the movable unit is six in the above-described embodiments. However, the number of the arms may be 1 to 5 or 7 or more.

The entire disclosure of Japanese Patent Application No. 2017-146229, filed Jul. 28, 2017 is expressly incorporated by reference herein.

What is claimed is:

1. A control device comprising:
a processor that is configured to execute computer-executable instructions so as to control a robot,
wherein the processor is configured to:
receive information relating to a first captured image from a first camera capable of capturing an image,
perform a command relating to drive of a robot having a hand capable of holding a workpiece, based on the information,
perform correlation between a robot coordinate system which is a coordinate system relating to the robot and a first image coordinate system which is a coordinate system relating to the first captured image, and
perform the correlation, based on a coordinate in the robot coordinate system of a predetermined site of the hand holding the workpiece when the workpiece is located at each of a plurality of positions inside an imaging region of the first camera and a coordinate in the first image coordinate system of the workpiece when the workpiece is located at each of the plurality of positions.

2. The control device according to claim 1,
wherein in the correlation, the processor is configured to use the first captured image captured when the workpiece is located at a first position inside the imaging region, and the first captured image captured when the workpiece is located at a second position different from the first position inside the imaging region.

3. The control device according to claim 1,
wherein the workpiece includes a first workpiece and a second workpiece different from the first workpiece, and
wherein in the correlation, the processor is configured to use the first captured image captured when the first workpiece is located at a first position inside the imaging region, and the first captured image captured when the second workpiece is located at a second position different from the first position inside the imaging region.

4. The control device according to claim 1,
wherein the workpiece includes a first workpiece and a second workpiece different from the first workpiece, and
wherein in the correlation, the processor is configured to use the first captured image captured when the first workpiece is located at a first position inside the imaging region and the second workpiece is located at a second position different from the first position inside the imaging region.

5. The control device according to claim 1,
wherein in the correlation, the processor is configured to obtain a coordinate in the robot coordinate system of the predetermined site in a state where the workpiece is held by the hand, and obtain a coordinate in the first captured image of the workpiece after the workpiece is detached from the hand.

6. The control device according to claim 1,
wherein the processor is configured to communicate with the first camera disposed so as to be capable of imaging a work table on which the workpiece is placed.

7. The control device according to claim 1,
wherein the processor is configured to receive information relating to second captured image from a second camera capable of capturing an image and different from the first camera, and
wherein the processor is configured to coordinate transformation between the robot coordinate system and a second image coordinate system which is a coordinate system relating to the second captured image, and obtain a position of the workpiece with respect to the predetermined site, based on the coordinate transformation.

8. The control device according to claim 7,
wherein the processor is configured to communicate with the second camera disposed so as to be capable of imaging the workpiece in a state where the workpiece is held by the hand.

9. A robot system comprising:
a robot; and
the control device a processor that is configured to execute computer-executable instructions so as to control the robot,
wherein the processor is configured to:
receive information relating to a first captured image from a first camera capable of capturing an image; and
perform a command relating to drive of a robot having a hand capable of holding a workpiece, based on the information,
perform correlation between a robot coordinate system which is a coordinate system relating to the robot and a first image coordinate system which is a coordinate system relating to the first captured image,
perform the correlation, based on a coordinate in the robot coordinate system of a predetermined site of the hand holding the workpiece when the workpiece is located at each of a plurality of positions inside an imaging region of the first camera and a coordinate in the first image coordinate system of the workpiece when the workpiece is located at each of the plurality of positions.

10. The robot system according to claim 9,
wherein in the correlation, the processor is configured to use the first captured image captured when the workpiece is located at a first position inside the imaging region, and the first captured image captured when the workpiece is located at a second position different from the first position inside the imaging region.

11. The robot system according to claim 9,
wherein the workpiece includes a first workpiece and a second workpiece different from the first workpiece, and
wherein in the correlation, the processor is configured to use the first captured image captured when the first workpiece is located at a first position inside the imaging region, and the first captured image captured when the second workpiece is located at a second position different from the first position inside the imaging region.

12. The robot system according to claim 9,
wherein the workpiece includes a first workpiece and a second workpiece different from the first workpiece, and
wherein in the correlation, the processor is configured to use the first captured image captured when the first workpiece is located at a first position inside the imaging region and the second workpiece is located at a second position different from the first position inside the imaging region.

13. The control device according to claim 9,
wherein in the correlation, the processor is configured to obtain a coordinate in the robot coordinate system of the predetermined site in a state where the workpiece is held by the hand, and obtain a coordinate in the first captured image of the workpiece after the workpiece is detached from the hand.

14. The control device according to claim 9,
wherein the processor is configured to communicate with the first camera disposed so as to be capable of imaging a work table on which the workpiece is placed.

15. The control device according to claim 9,
wherein the processor is configured to receive information relating to second captured image from a second camera capable of capturing an image and different from the first camera, and
wherein the processor is configured to coordinate transformation between the robot coordinate system and a second image coordinate system which is a coordinate system relating to the second captured image, and obtain a position of the workpiece with respect to the predetermined site, based on the coordinate transformation.

16. The control device according to claim 15,
wherein the processor is configured to communicate with the second camera disposed so as to be capable of imaging the workpiece in a state where the workpiece is held by the hand.

17. A control method comprising:
correlating a robot coordinate system which is a coordinate system relating to a robot having a hand capable of holding a workpiece, and a first image coordinate system which is a coordinate system relating to a first captured image obtained from a first camera capable of capturing an image; and
driving the robot, based on a result of the correlating and information relating to the first captured image obtained from the first camera,
wherein in the correlating, the correlating is performed, based on a coordinate in the robot coordinate system of a predetermined site of the hand holding the workpiece when the workpiece is located at each of a plurality of positions inside an imaging region of the first camera and a coordinate in the first image coordinate system of the workpiece when the workpiece is located at each of the plurality of positions.
